(19) United States
(12) Patent Application Publication
(10) Pub. No.: US 2016/0091069 A1
(43) Pub. Date: Mar. 31, 2016

(54) PLANETARY GEAR TRAIN OF AUTOMATIC TRANSMISSION FOR VEHICLE

(71) Applicant: Hyundai Motor Company, Seoul (KR)

(72) Inventors: Changwook LEE, Suwon-si (KR); Jaechang Kook, Hwaseong-si (KR); Jongsool Park, Hwaseong-si (KR); Kangsoo Seo, Yongin-si (KR); Donghwan Hwang, Seoul (KR)

(73) Assignee: Hyundai Motor Company, Seoul (KR)

(21) Appl. No.: 14/557,746

(22) Filed: Dec. 2, 2014

(30) Foreign Application Priority Data
Sep. 26, 2014 (KR) 10-2014-0129257

(51) Int. Cl. F16H 37/04

(52) U.S. Cl. CPC F16H 37/042; F16H 2200/0065; F16H 2200/0082; F16H 2200/2007; F16H 2200/2046

(57) ABSTRACT

A planetary gear train of an automatic transmission for a vehicle including a first shaft receiving torque of an engine, a second shaft disposed in parallel with the first shaft at a predetermined distance, a first planetary gear set disposed on the first shaft, and including a first rotation element, a second rotation element, and a third rotation element, a second planetary gear set disposed on the second shaft, and including a fourth rotation element connected to the second rotation element through an externally-meshed gear, a fifth rotation element connected to the third rotation element through an externally-meshed gear, and a sixth rotation element selectively connected to the first shaft through two paths including respectively externally-meshed gears, four transfer gears forming the externally-meshed gears, and frictional elements including clutches and a brake.

### CROSS-REFERENCE TO RELATED APPLICATION

The present application claims priority to Korean Patent Application No. 10-2014-0129257 filed Sep. 26, 2014, the entire contents of which is incorporated herein for all purposes by this reference.

### BACKGROUND OF THE INVENTION

1. Field of the Invention

The present invention relates to an automatic transmission for a vehicle. More particularly, the present invention relates to a planetary gear train of an automatic transmission for a vehicle that can improve mountability and power delivery performance and reduce fuel consumption.

2. Description of Related Art

Typically, multiple-shift mechanism of an automatic transmission is achieved by combining a plurality of planetary gear sets and a plurality of frictional elements.

It is well known that when a planetary gear train realizes a greater number of shift speeds, speed ratios of the planetary gear train can be more optimally designed, and therefore a vehicle can have economical fuel mileage and better performance. For that reason, the planetary gear train that is able to realize more shift speeds is under continuous investigation.

Though achieving the same number of speeds, the planetary gear train has a different operating mechanism according to a connection between rotation elements (i.e., sun gear, planet carrier, and ring gear). In addition, the planetary gear train has different features such a durability, power delivery efficiency, and size depending on the layout thereof. Therefore, designs for a combining structure of a gear train are also under continuous investigation.

If the number of shift-speeds, however, increases, the number of components in the automatic transmission also increases. Therefore, mountability, cost, weight and power delivery efficiency may be deteriorated.

Particularly, since the planetary gear train having a number of components is hard to be mounted in a front wheel drive vehicle, researches for minimizing the number of components have been developed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a planetary gear train of an automatic transmission for a vehicle having advantages of improving mountability by shortening a length thereof and reducing the number of components as a consequence of achieving nine forward speeds and one reverse speed by disposing two planetary gear sets separately on a first shaft and a second shaft disposed in parallel with each other and connecting rotation elements of the planetary gear sets through a plurality of externally-meshed gears.

In addition, various aspects of the present invention are directed to providing a planetary gear train of an automatic transmission for a vehicle having further advantages of enabling of setting optimum gear ratios due to ease of changing gear ratios by using a plurality of externally-meshed gears, and accordingly improving power delivery performance and fuel economy.

According to various aspects of the present invention, a planetary gear train of an automatic transmission for a vehicle may include a first shaft receiving torque of an engine, a second shaft disposed in parallel with the first shaft with a predetermined distance, a first planetary gear set disposed on the first shaft, and including a first rotation element selectively connected to the first shaft, a second shaft rotation element selectively connected to the first shaft and selectively connected to a transmission housing, and a third rotation element, a second planetary gear set disposed on the second shaft, and including a fourth rotation element connected to the second rotation element through an externally-meshed gear and directly connected to an output shaft, and a sixth rotation element selectively connected to the first shaft through tow paths including respectively externally-meshed gears, four transfer gears forming the externally-meshed gears, and frictional elements including clutches selectively connecting the first shaft to rotation element of the first and second planetary gear sets and a brake selectively connecting rotation elements of the first and second planetary gear sets to the transmission housing.

The first planetary gear sets may be a single pinion planetary gear set including a first sun gear being the first rotation element, a first planet carrier being the second rotation element, and a first ring gear being the third rotation element, and the second planetary gear set may be a single pinion planetary gear set including a second sun gear being the fourth rotation element, a second planet carrier being the fifth rotation element, and a second ring gear being the sixth rotation element.

The first planetary gear set may be a double planetary gear set including a first sun gear being the first rotation element, a first ring gear being the second rotation element, and a first planet carrier being the third rotation element, and the second planetary gear set may be a single pinion planetary gear set including a second sun gear being the fourth rotation element, a second planet carrier being the fifth rotation element, and a second ring gear being the sixth rotation element.

The first planetary gear set may be a single pinion planetary gear set including a first sun gear being the first rotation element, a first planet carrier being the second rotation element, and first ring gear being the third rotation element, and the second planetary gear set may be a double pinion planetary gear set including a second sun gear being the fourth rotation, a second ring gear being the fifth rotation element, and a second planet carrier being the sixth rotation element.

The four transfer gears may include a first transfer gear connecting the second rotation element to the fourth rotation element, a second transfer gear connecting the third rotation element to the fifth rotation element, a third transfer gear connecting the first shaft to the sixth rotation element, and a fourth transfer gear connecting the first shaft to the sixth rotation element, wherein a gear ratio of the third transfer gear may differ from that of the fourth transfer gear.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the third transfer gear and the sixth rotation element, a fifth clutch disposed between the fourth rotation element and the fifth rotation element, and a first brake disposed between the fourth rotation element and the transmission housing.

The first clutch and the first brake may be operated at a first forward speed, the first clutch and the fifth clutch may be operated at a second forward speed, the first clutch and the second clutch may be operated at a third forward speed, the first clutch and the third clutch may be operated at a fourth forward speed, the second clutch and the third clutch may be operated at a fifth forward speed, the third clutch and the fifth clutch may be operated at a sixth forward speed, the third clutch and the fourth clutch may be operated at a seventh forward speed, the fourth clutch and the fifth clutch may be operated at e eighth forward speed, the second clutch and the fourth clutch may be operated at a ninth forward speed, and the second clutch and the first brake may be operated at a reverse speed.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the third transfer gear and the sixth rotation element, a fifth clutch disposed between the fourth rotation element and the fifth rotation element, and a first brake disposed between the second rotation element and the transmission housing.

The frictional elements may include a first clutch disposed between the first shaft and the fourth transfer gear, a second clutch disposed between the first shaft and the first rotation element, a third clutch disposed between the first shaft and the second rotation element, a fourth clutch disposed between the third transfer gear and the sixth rotation element, a fifth clutch disposed between the fourth rotation element and the fifth rotation element, and a first brake disposed between the fourth rotation element and the transmission housing.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the first shaft and the third transfer gear, a fifth clutch disposed between the fourth rotation element and the fifth rotation element, and a first brake disposed between the fourth rotation element and the transmission housing.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the first shaft and the third transfer gear, a fifth clutch disposed between the fourth rotation element and the sixth rotation element, and a first brake disposed between the fourth rotation element and the transmission housing.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the first shaft and the third transfer gear, a fifth clutch disposed between the fifth rotation element and the sixth rotation element; and the first brake disposed between the fourth rotation element and the transmission housing.

According to various aspects of the present invention, a planetary gear train of an according to another aspect of the present invention may include a first shaft receiving torque of an engine, a second shaft disposed in parallel with the first shaft, a first planetary gear set disposed on the first shaft and including a first rotation element selectively connected to the first shaft and selectively connected to a transmission housing, and a third rotation element, a second planetary gear set disposed on the second shaft, and including a fourth rotation element connected to the second rotation element and selectively connected to the transmission housing, a fifth rotation element connected to the third rotation element and directly connected to the first shaft through two paths, a first transfer gear connecting the second rotation element to the fourth rotation element, a second transfer gear connecting the third rotation element to the fifth rotation element, a third transfer gear connecting the first shaft to the sixth rotation element, a fourth transfer gear connecting the first shaft to the sixth rotation element, and frictional elements including clutches selectively connecting the first shaft to rotation elements of the first and second planetary gear sets and a brake selectively connecting rotation elements of the first and second planetary gear sets to the transmission housing, wherein a gear ratio of the third transfer gear differs from that of the fourth transfer gear.

The first planetary gear set may be a single pinion planetary gear set including a first sun gear being the first rotation element, a first planet carrier being the second rotation element, and a first ring gear being the third rotation element, and the second planetary gear set may be a single pinion planetary gear set including a second sun gear being the fourth rotation element, a second planet carrier being the fifth rotation elements, and a second ring gear being the sixth rotation element.

The first planetary gear set may be a double pinion planetary gear set including a first sun gear being the first rotation element, a first ring gear being the second rotation element, and a first planet carrier being the third rotation element, and the second planetary gear set may be a single pinion planetary gear set including a second sun gear being the fourth rotation element, a second planet carrier being the fifth rotation element, and a second ring gear being the sixth rotation element.

The first planetary gear set may be a single pinion planetary gear set including a first sun gear being the firsts rotation element, a first planet carrier being the second rotation element, and a first ring gear being the third rotation element, and the second planetary gear set may be a double pinion planetary gear set including a second sun gear being the fourth rotation element, a second ring gear being the fifth rotation element, and a second planet carrier being the sixth rotation element.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the third transfer gear and the sixth rotation element, a fifth clutch disposed between the fourth rotation element and the fifth rotation element, and a first brake disposed between the fourth rotation element and the transmission housing.

The first clutch and the first brake may be operated at a first forward speed, the first clutch and the fifth clutch may be operated at a second forward speed, the first clutch and the second clutch may be operated at a third forward speed, the first clutch and the third clutch may be operated at a fourth forward speed, the second clutch and the third clutch may be operated at a fifth forward speed, the third clutch and the fifth clutch may be operated at a sixth forward speed, the third clutch and the fourth clutch may be operated at a seventh forward speed, the fourth clutch and the fifth clutch may be operated at a eighth forward speed, the second clutch and the fourth clutch may be operated at a ninth forward speed, and the second clutch and the first brake may be operated at a reverse speed.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the third transfer gear and the sixth rotation element, a fifth clutch disposed between the fourth rotation element and the fifth rotation element, and a first brake disposed between the second rotation element and the transmission housing.

The frictional elements may include a first clutch disposed between the first shaft and the fourth transfer gear, a second clutch disposed between the first shaft and the first rotation element, a third clutch disposed between the first shaft and the second rotation element, a fourth clutch disposed between the third transfer gear and the sixth rotation element, a fifth clutch disposed between the fourth rotation element and the fifth rotation element, and a first brake disposed between the fourth rotation element and the transmission housing.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the first shaft and the third transfer gear, a fifth clutch disposed between the fourth rotation element and the fifth rotation element, and a first brake disposed between the fourth rotation element and the transmission housing.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the first shaft and the third transfer gear, a fifth clutch disposed between the fourth rotation element and the sixth rotation element, and a first brake disposed between the fourth rotation element and the transmission housing.

The frictional elements may include a first clutch disposed between the fourth transfer gear and the sixth rotation element, a second clutch disposed between the first shaft and the first rotation element, a third clutch disposed between the first shaft and the second rotation element, a fourth clutch disposed between the first shaft and the third transfer gear, a fifth clutch disposed between the fifth rotation element and the sixth rotation element, and a first brake disposed between the fourth rotation element and the transmission housing.

Nine forward speeds and one reverse speed can be achieved by combining two planetary gear sets being simple planetary gear sets, four transfer gears, and six frictional elements according to exemplary embodiments of the present invention.

In addition, since two planetary gear sets are disposed separately on the first shaft and the second shaft disposed in parallel with a predetermined distance, a length thereof may be reduced and mountability may be improved.

In addition, optimum gear ratios may be set due to ease of charging gear ratios by using four externally-meshed gears as well as the planetary gear sets. Since gear ratios can be changed according to target performance, starting performance, power delivery performance, and fuel economy may be improved. Therefore, a start-up clutch instead of a torque converter may be used.

In addition, two frictional elements are operated at each shift-speed and one frictional element is released and another frictional element is operated so as to shift to a neighboring shift-speed. Therefore, shift control condition is fully satisfied.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary planetary gear train according to the present invention.

FIG. 2 is an operational chart of frictional elements at each shift-speed applied to the exemplary planetary gear train according to the present invention.

FIG. 3 is a lever diagram of the exemplary planetary gear train according to the present invention.

FIG. 4 is a schematic diagram of an exemplary planetary gear train according to the present invention.

FIG. 5 is a schematic diagram of an exemplary planetary gear train according to the present invention.

FIG. 6 is a schematic diagram of an exemplary planetary gear train according to the present invention.

FIG. 7 is a schematic diagram of an exemplary planetary gear train according to the present invention.

FIG. 8 is a schematic diagram of an exemplary planetary gear train according to the present invention.

FIG. 9 is a schematic diagram of an exemplary planetary gear train according to the present invention.

FIG. 10 is a schematic diagram of an exemplary planetary gear train according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

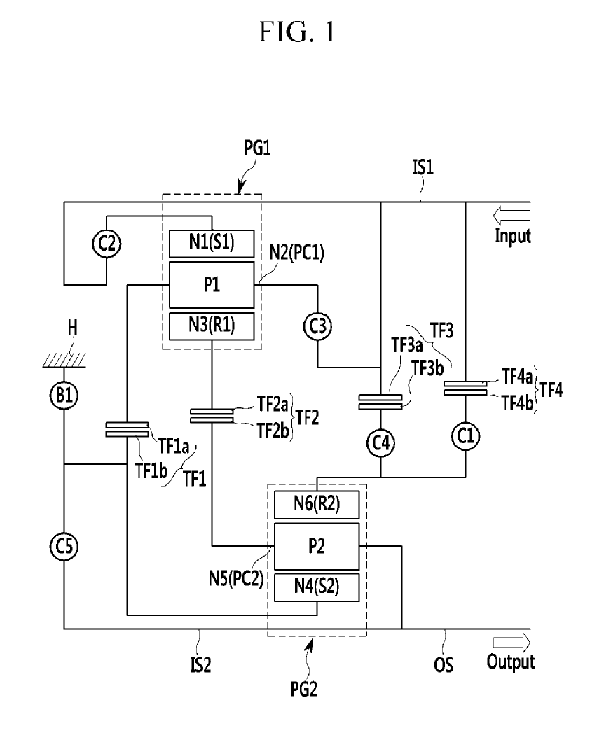

FIG. 1 is a schematic diagram of a planetary gear train according to various embodiments of the present invention.

Referring to FIG. 1, a planetary gear train according to various embodiments of the present invention includes a first planetary gear set PG1 disposed on a first shaft IS1, a second planetary gear set PG2 disposed on a second shaft IS2 disposed in parallel with the first shaft IS1, four transfer gears TF1, TF2, TF3, and TF4, and frictional elements consisting five clutches C1, C2, C3, C4, and C5 and one brake B1.

Therefore, torque input from the first shaft IS1 is converted into nine forward speeds and one reverse speed by cooperation of the first and second planetary gear sets PG1 and PG2, and is then output through an output shaft OS.

The first shaft IS1 is an input member, and torque from a crankshaft of an engine is changed through a torque converter and is then input to the first shaft IS1. The first shaft IS1 supports the first planetary gear set PG1 without rotational interference therebetween.

The second shaft IS2 is disposed in parallel with the first shaft IS1 with a predetermined distance and rotatably supports the second planetary gear set PG2.

The first planetary gear set PG1 is a single pinion planetary gear set, and includes a first rotation element N1 being a first sun gear S1, a second rotation element N2 being a first planet carrier PC1 rotatably supporting a first pinion P1 externally meshed with the first sun gear S1, and a third rotation element N3 being a first ring gear R1 internally meshed with the first pinion P1.

The second planetary gear set PG2 is a single pinion planetary gear set, and includes a fourth rotation element N4 being a second sun gear S2, a fifth rotation element N5 being a second planet carrier PC2 rotatably supporting a second pinion P2 externally meshed with the second sun gear S2, and a sixth rotation element N6 being a second ring gear R2 internally meshed with the second pinion P2.

The first rotation element N1 is selectively connected to the first shaft IS1, and the second rotation element N2 is selectively connected to the first shaft IS1.

The fourth rotation element N4 is connected to the second rotation element N2 through an externally-meshed gear and is selectively connected to the transmission housing H. The fifth rotation element N5 is connected to the third rotation element N3 through an externally-meshed gear and is directly connected to the output shaft OS. The sixth rotation element N6 is selectively connected to the first shaft IS1 through two paths including respectively externally-meshed gears.

The output shaft OS drives a driving axle including a driving wheel through a final reduction gear and a differential apparatus.

The first, second, third, and fourth transfer gear TF1, TF2, TF3, and TF4 respectively have first, second, third, and fourth transfer drive gears TF1a, TF2a, TF3a, and TF4a and first, second, third, and fourth transfer driven gears TF1b, TF2b, TF3b, and TF4b externally meshed with each other. Gear ratios of the first, second, third, and fourth transfer gears TF1, TF2, TF3, and TF4 are set according to speed ratios demanded at shift-speeds.

The first transfer gear TF1 externally meshes the second rotation element N2 to the fourth rotation element N4.

The second transfer gear TF2 externally meshes the third rotation element N3 to the fifth rotation element N5.

The third transfer gear TF3 externally meshes the first shaft IS1 to the sixth rotation element N6.

The fourth transfer gear TF4 externally meshes the first shaft IS1 to the sixth rotation element N6.

Therefore, the rotation elements connected through the first, second, third, and fourth transfer gears TF1, TF2, TF3, and TF4 are rotated in opposite direction to each other according to gear ratios of the first, second, third, and fourth transfer gears TF1, TF2, TF3, and TF4.

The third and fourth transfer gears TF3 and TF4 connect the first shaft IS1 to the sixth rotation element N6, and the gear ratio of the third transfer gear TF3 differs from that of the fourth transfer gear TF4.

In addition, five clutches C1, C2, C3, C4, and C5 connecting selected rotation elements with each other and one brake B1 connecting selected rotation elements to the transmission housing H are disposed as follows.

The first clutch C1 selectively connects the first shaft IS1 to the sixth rotation element N6 and is disposed between the fourth transfer gear TF4 and the sixth rotation element N6.

The second clutch C2 is disposed between the first shaft IS1 and the first rotation element N1.

The third clutch C3 is disposed between the first shaft IS1 and the second rotation element N2.

The fourth clutch C4 selectively connects the first shaft IS1 to the sixth rotation element N6 and is disposed between the third transfer gear TF3 and the sixth rotation element N6.

The fifth clutch C5 is a direct-coupling device which causes the second planetary gear set PG2 to become a direct-coupling state. For this purpose, the fifth clutch C5 is disposed between the fourth rotation element N4 and fifth rotation element N5. Since the second shaft IS2 is directly connected to the fifth rotation element N5 according to various embodiments of the present invention, the fifth clutch C5 is disposed between the fourth rotation element N4 and the second shaft IS2.

The first brake B1 is disposed between the fourth rotation element N4 and the transmission housing H and is adapted to cause the second rotation element N2 and the fourth rotation element N4 to be selectively operated as a fixed element.

The frictional elements consisting of the first, second, third, fourth, and fifth clutches C1, C2, C3, C4, and C5 and the first brake B1 are conventional multi-plate friction elements of wet type that are operated by hydraulic pressure.

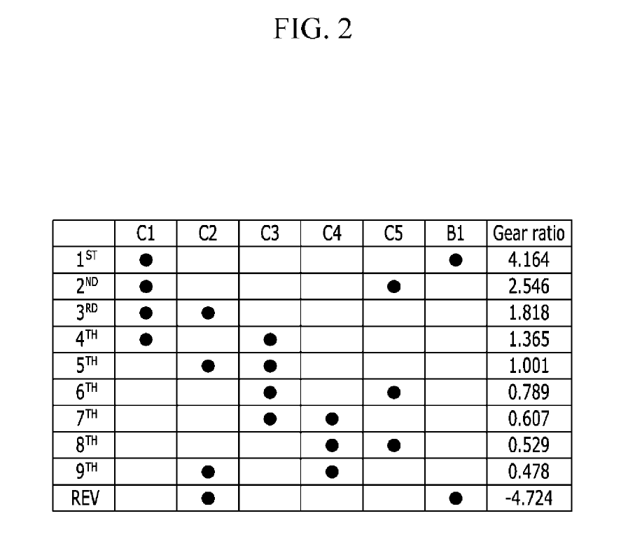

FIG. 2 is an operational chart of frictional elements at each shift-speed applied to a planetary gear train according to various embodiments of the present invention.

As shown in FIG. 2, two frictional elements are operated at each shift-speed in the planetary gear train according to various embodiments of the present invention.

The first clutch C1 and the first brake B1 are operated at a first forward speed 1^{ST}.

The first clutch C1 and the fifth clutch C5 are operated at a second forward speed 2^{ND}.

The first clutch C1 and the second clutch C2 are operated at a third forward speed 3^{RD}.

The first clutch C1 and the third clutch C3 are operated at a fourth forward speed 4^{TH}.

The second clutch C2 and the third clutch C3 are operated at a fifth forward speed 5^{TH}.

The third clutch C3 and the fifth clutch C5 are operated at a sixth forward speed 6^{TH}.

The third clutch C3 and the fourth clutch C4 are operated at a seventh forward speed 7^{TH}.

The fourth clutch C4 and the fifth clutch C5 are operated at an eighth forward speed 8^{TH}.

The second clutch C2 and the fourth clutch C4 are operated at a ninth forward speed 9^{TH}.

The second clutch C2 and the first brake B1 are operated at a reverse speed REV.

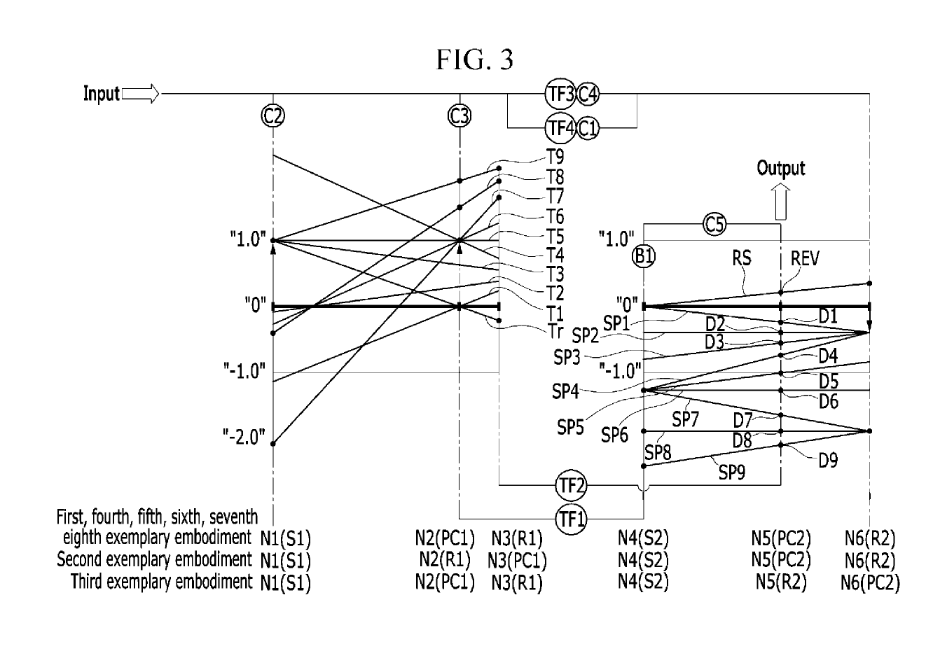

FIG. 3 is a lever diagram of a planetary gear train according to various embodiments of the present invention, and illustrates shift processes of the planetary gear train according to the various embodiments of the present invention by lever analysis method.

Referring to FIG. 3, three vertical lines of the first planetary gear set PG1 are set as the first, second, and third rotation elements N1, N2, and N3 from the left.

Three vertical lines of the second planetary gear set PG2 are set as the fourth, fifth, and sixth rotation elements N4, N5, and N6 from left. A middle horizontal line represents a rotation speed of “0”, an upper horizontal line represents positive rotation speed and a lower horizontal line represents negative rotation speed.

“−” indicates that rotation elements are rotated in an opposite direction to the rotation direction of the engine. In is because the rotation elements are externally meshed through the first, second, third, and fourth transfer gears TF1, TF2, TF3, and TF4 without an idling gear.

In addition, distances between the vertical lines of the first and second planetary gear sets PG1 and PG2 are set according to gear ratios (teeth number of a sun gear/teeth number of a ring gear).

Heareinafter, referring to FIG. 2 and FIG. 3, the shift processes of the planetary gear train according to various embodiments of the present invention will be described in detail.

[First Forward Speed]

Referring to FIG. 2, the first clutch C1 and the first brake B1 are operated at the first forward speed 1^{ST}.

As shown in FIG. 3, torque of the first shaft IS1 is changed according to the gear ratio of the fourth transfer gear TF4 and is then input to the sixth rotation element N6 as inverse rotation speed by operation of the first clutch C1. In addition, the fourth rotation element N4 is operated as the fixed element by operation of the first brake B1.

Therefore, the rotation elements of the second planetary gear set PG2 form a first shift line SP1, and D1 is output through the fifth rotation element N5 that is an output element.

At this state, the second rotation element N2 is operated as the fixed element by operation of the first brake B1, and torque of the fifth rotation element N5 is changed according to the gear ratio of the second transfer gear TF2 and is then input to the third rotation element N3. That is, the rotation elements of the first planetary gear set PG1 form a first forward speed line T1, but it does not have any effect on shifting.

[Second Forward Speed]

Referring to FIG. 2, the first brake B1 that was operated at the first forward speed 1^{ST} is released and the fifth clutch C5 is operated at the second forward speed 2^{ND}.

As shown in FIG. 3, torque of the first shaft IS1 is changed according to the gear ratio of the fourth transfer gear TF4 and is then input to the sixth rotation element N6 as inverse rotation speed by operation of the first clutch C1.

In addition, the second planetary gear set PG2 becomes a direct-coupling state by operation of the fifth clutch C5. Therefore, the rotation elements of the second planetary gear set PG2 form a second shift line SP2 and D2 is output through the fifth rotation element N5 that is the output element.

At this state, torque of the fifth rotation element N5 is changed according to the gear ratio of the first and second transfer gears TF1 and TF2 and is then input to the second and third rotation elements N2 and N3. That is, the rotation elements of the first planetary gear set PG1 form a second forward speed line T2, but it does not have any effect on shifting.

[Third Forward Speed]

Referring to FIG. 2, the fifth clutch C5 that was operated at the second forward speed 2^{ND} is released and the second clutch C2 is operated at the third forward speed 3^{RD}.

As shown in FIG. 3, the torque of the first shaft IS1 is changed according to the gear ratio of the fourth transfer gear TF4 and is then input to the sixth rotation element N6 as inverse rotation speed by operation of the first clutch C1. In addition, the torque of the first shaft IS1 is input to the first rotation element N1 by operation of the second clutch C2.

Since the second rotation element N2 is connected to the fourth rotation element N4 through the first transfer gear TF1 and the third rotation element N3 is connected to the fifth rotation element N5 through the second transfer gear TF2, the rotation elements of the first planetary gear set PG1 form a third forward speed line T3 and the rotation elements of the second planetary gear set PG2 form a third shift line SP3 by cooperation of the rotation elements of the first planetary gear set PG1 and the second planetary gear set PG2. Therefore, D3 is output through the fifth rotation element N5 that is the output element.

[Fourth Forward Speed]

Referring to FIG. 2, the second clutch C2 that was operated at the third forward speed 3^{RD} is released and the third clutch C3 is operated at the fourth forward speed 4^{TH}.

As shown in FIG. 3, the torque of the first shaft IS1 is changed according to the gear ratio of the fourth transfer gear TF4 and is then input to the sixth rotation element N6 as inverse rotation speed by operation of the first clutch C1. In addition, the torque of the first shaft IS1 is input to the second rotation element N2 by operation of the third clutch C3.

Since the second rotation element N2 is connected to the fourth rotation element N4 through the first transfer gear TF1 and the third rotation element N3 is connected to the fifth rotation element N5 through the second transfer gear TF2, the rotation elements of the first planetary gear set PG1 form a fourth forward speed line T4 and the rotation elements of the second planetary gear set PG1 for a fourth shift line SP4 by cooperation of the rotation elements of the first planetary gear set PG1 and second planetary gear set PG2. Therefore, D4 is output through the fifth rotation element N5 that is the output element.

[Fifth Forward Speed]

Referring to FIG. 2, the first clutch C1 that was operated at the fourth forward speed 4^{TH} is released and the second clutch C2 is operated at the fifth forward speed 5^{TH}.

As shown in FIG. 3, the torque of the first shaft IS1 is input to the first rotation element N1 by operation of the second clutch C2 and is input to the second rotation element N2 by operation of the third clutch C3.

Therefore, the first planetary gear set PG1 becomes a direct-coupling state by operation of the second clutch C2 and the third clutch C3, and the rotation elements of the first planetary gear set PG1 for a fifth forward speed lien T5. At this state, torques of the second and third rotation elements N2 and N3 are changed according to the gear ratios of the first and second transfer gears TF1 and TF2 and are then input to the fourth and fifth rotation elements N4 and N5.

Therefore, the rotation elements of the second planetary gear set PG2 form a fifth shift line SP5, and D5 is output through the fifth rotation element N5 that is the output element.

[Sixth Forward Speed]

Referring to FIG. 2, the second clutch C2 that was operated at the fifth forward speed 5^{TH} is release and the fifth clutch C5 is operated at the sixth forward speed 6^{TH}.

As shown in FIG. 3, the torque of the first shaft IS1 is input to the second rotation element N2 by operation of the third clutch C3, and the second planetary gear set PG2 becomes the direct-coupling state.

Therefore, the rotation elements of the first planetary gear set PG1 form a sixth forward speed line T6 and the rotation elements of the second planetary gear set PG2 form a sixth shift line SP6 by cooperation of the first planetary gear set PG1 and the second planetary gear set PG2. Therefore, D6 is output through the fifth rotation element N5 that is the output element.

[Seventh Forward Speed]

Referring to FIG. 2, the fifth clutch C5 that was operated at the sixth forward speed 7^{TH} is released and the fourth clutch C4 is operated at the seventh forward speed 7^{TH}.

As shown in FIG. 3, the torque of the first shaft IS1 is input to the second rotation element N2 by operation of the third clutch C3. In addition, the torque of the first shaft IS1 is changed according to the gear ratio of the third transfer gear TF3 and is then input to the sixth rotation element N6 as inverse rotation speed by operation of the fourth clutch C4.

Therefore, the rotation elements of the first planetary gear set PG1 form a seventh forward speed line T7 and the rotation elements of the second planetary gear set PG2 form a seventh shift line SP7 by cooperation of the first planetary gear set PG1 and the second planetary gear set PG2. Therefore, D7 is output through the fifth rotation element N5 that is the output element.

[Eighth Forward Speed]

Referring to FIG. 2, the third clutch C3 that was operated at the seventh forward speed 7^{TH} is released and the fifth clutch C5 is operated at the eighth forward speed 8^{TH}.

As shown in FIG. 3, the torque of the first shaft IS1 is changed according to the gear ratio of the third transfer gear TF3 and is then input to the sixth rotation element N6 as inverse rotation speed by operation of the fourth clutch C4. In addition, the second planetary gear set PG2 becomes the direct-coupling state by operation of the fifth clutch C5.

Therefore, the rotation elements of the first planetary gear set PG1 form an eighth forward speed line T8 and the rotation elements of the second planetary gear set PG2 form an eighth shift line SP8 by cooperation of the first planetary gear set PG1 and the second planetary gear set PG2. Therefore, D8 is output through the fifth rotation element N5 that is the output element.

[Ninth Forward Speed]

Referring to FIG. 2, the fifth clutch C5 that was operated at the eighth forward speed 8^{TH} is released and the second clutch C2 is operated at the ninth forward speed 9^{TH}.

As shown in FIG. 3, the torque of the first shaft IS1 is changed according to the gear ratio of the third transfer gear TF3 and is then input to the sixth rotation element N6 as inverse rotation speed by operation of the fourth clutch C4. In addition, the torque of the first shaft IS1 is input to the first rotation element N1 by operation of the second clutch C2.

Therefore, the rotation elements of the first planetary gear set PG1 form a ninth forward speed line T9 and the rotation elements of the second planetary gear set PG2 form ninth shift line SP9 by cooperation of the first planetary gear set PG1 and the second planetary gear set PG2. Therefore, D9 is output through the fifth rotation element N5 that is the output element.

[Reverse Speed]

Referring to FIG. 2, the second clutch C2 and the first brake B1 are operated at the reverse speed REV.

As shown in FIG. 3, the torque of the first shaft IS1 is input to the first rotation element N1 by operation of the second clutch C2. In addition, the second and fourth rotation elements N2 and N4 are operated as the fixed elements by operation of first brake B1.

Therefore, the rotation elements of the first planetary gear set PG1 form a reverse speed line Tr and the rotation elements of the second planetary gear set PG2 form a reverse shift line RS by cooperation of the first planetary gear set PG1 and the second planetary gear set PG2. Therefore, REV is output through the fifth rotation element N5 that is the output element.

As described above, the planetary gear train according to various embodiments of the present invention can achieve nine forward speeds and one reverse speed by combining two planetary gear sets PG1 and PG2 being the simple planetary gear sets with four transfer gears TF1, TF2, TF3, and TF4 being the externally-meshed gears and six frictional elements C1, C2, C3, C4, C4, and B1.

In addition, optimum gear ratios may be set due to ease of changing gear ratios by using four transfer gears TF1, TF2, TF3, and TF4 being externally-meshed gears as well as the planetary gear sets PG1 and PG2. Since gear ratios can be changed according to target performance, starting performance, power delivery performance and fuel economy may be improved. Therefore, a start-up clutch instead of a torque converter may be used.

In addition, two frictional elements are operated at each shift-speed and one frictional element is released and another frictional element is operated so as to shift a neighboring shift-speed. Therefore, shift control condition is fully satisfied.

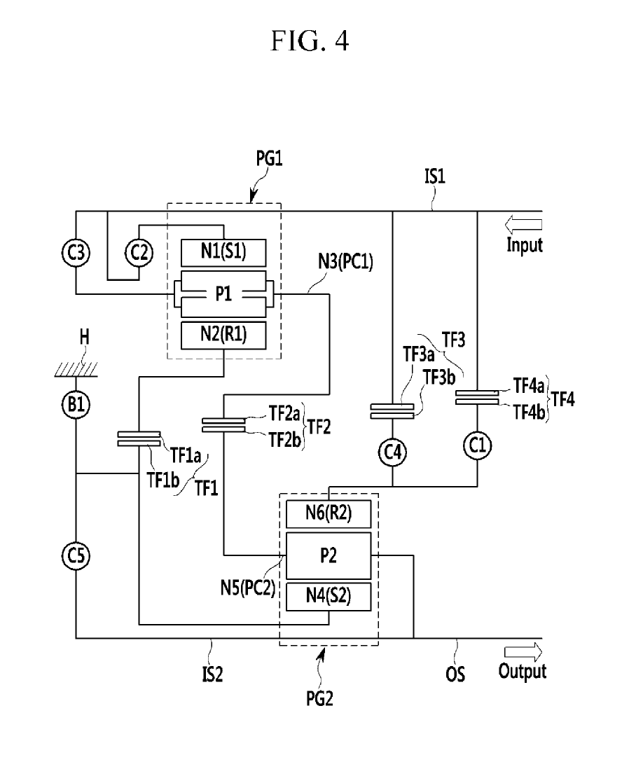

FIG. 4 is a schematic diagram of a planetary gear train according to various embodiments of the present invention.

Referring to FIG. 4, the first planetary gear set PG1 is the single pinion planetary gear set in previously described embodiments, but the first planetary gear set PG1 is a double pinion planetary gear set in various embodiments described in FIG. 4.

Therefore, the second rotation element N2 is changed from the first planet carrier PC1 to the first ring gear R1, and the third rotation element N3 is changed from the first ring gear R1 to the first planet carrier PC1.

Since functions and other components of the various embodiments described in FIG. 4 are same as those of the previously described embodiments except the rotation elements consisting of the second and third rotation elements N2 and N3, detailed description thereof will be omitted.

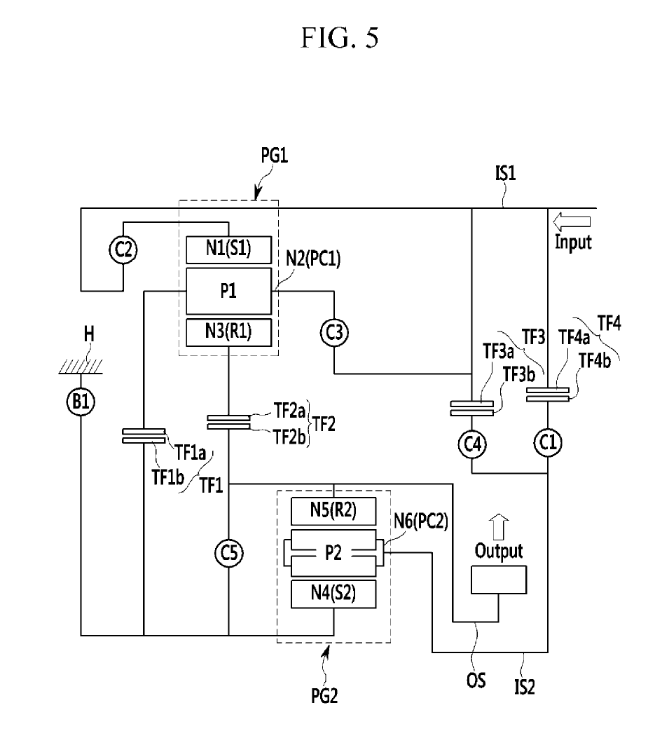

FIG. 5 is a schematic diagram of a planetary gear train according to various embodiments of the present invention.

Referring to FIG. 5, the second planetary gear set PG2 is the single pinion planetary gear set in the previously described embodiments, but second planetary gear set PG2 is a double pinion planetary gear set in various embodiments described in FIG. 5.

Therefore, the fifth rotation element N5 is changed from the second planet carrier PC2 to the second ring gear R2 and the sixth rotation element N6 is changed from the second ring gear R2 to the second planet carrier PC2.

The sixth rotation element N6 is selectively connected to the third and fourth transfer gears TF3 and TF4 through the second shaft IS2 in various embodiments described in FIG. 5. The output shaft OS is a hollow shaft and is disposed at a radial exterior of the second shaft IS2 without rotational interference with the second shaft IS2. In addition, the output shaft OS is directly connected to the fifth rotation element N5.

Since functions and other components of various embodiments described in FIG. 5 are same as those of the previously described embodiments except the rotation elements consisting of the fifth and sixth rotation elements N5 and N6, detailed description thereof will be omitted.

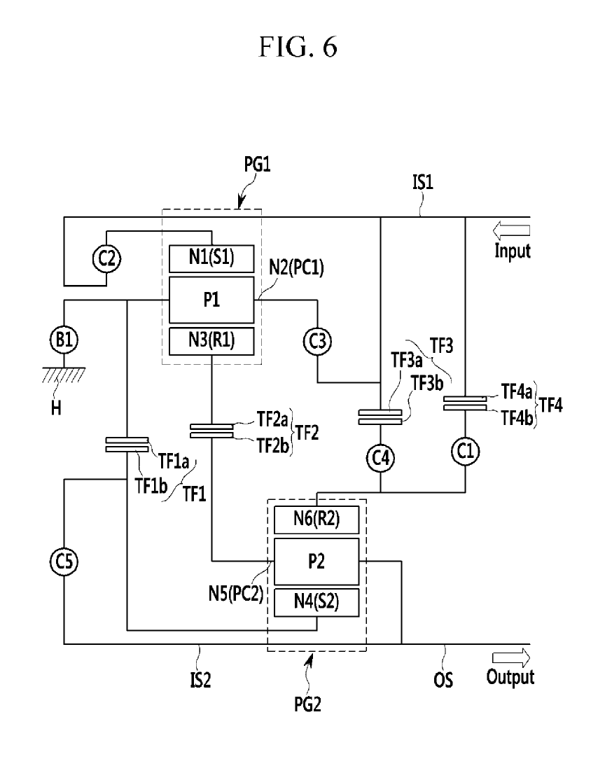

FIG. 6 is a schematic diagram of a planetary gear train according to various embodiments of the present invention.

Referring to FIG. 6, the first brake B1, which is adapted to cause the second and fourth rotation elements N2 and N4 to be selectively operated as the fixed elements, is disposed between the fourth element N4 and the transmission housing H in the previously described embodiments, but the first brake B1 is disposed between the second rotation element N2 and the transmission housing H in various embodiments described in FIG. 6.

Since functions and other components in various embodiments described in FIG. 6 are same as those of the previously described embodiments except the position of the first brake B1, detailed description thereof will be omitted.

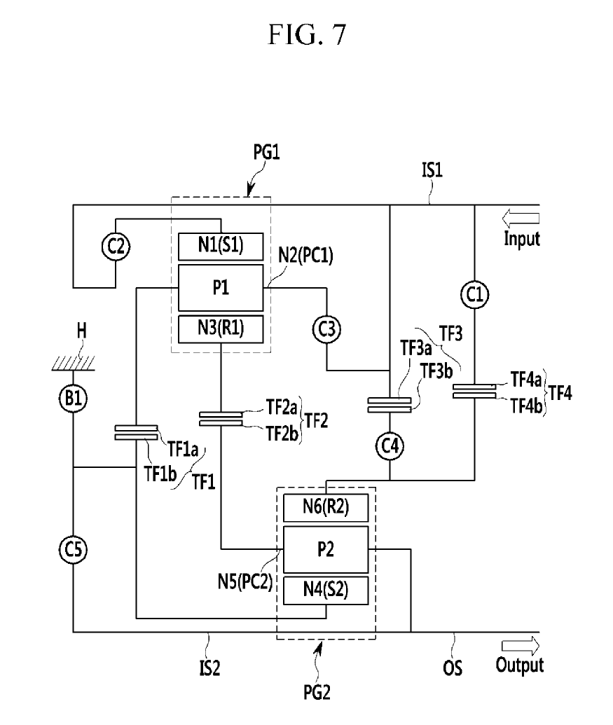

FIG. 7 is a schematic diagram of a planetary gear train according to various embodiments of the present invention.

Referring to FIG. 7, the first clutch C1 is disposed between the fourth transfer gear TF4 and the sixth rotation element N6 in the previously described embodiments, but the first clutch C1 is disposed between the first shaft IS1 and the fourth transfer gear TF4 in various embodiments described in FIG. 7.

Since functions and other components in the various embodiments described in FIG. 7 are same as those of the previously described embodiments except the position of the first clutch C1, detailed description thereof will be omitted.

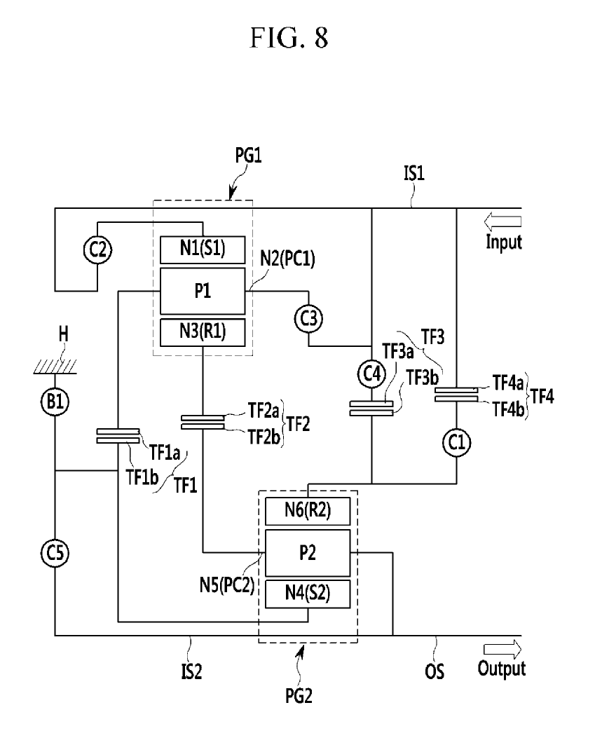

FIG. 8 is a schematic diagram of a planetary gear train according to various embodiments of the present invention.

Referring to FIG. 8, the fourth clutch C4 is disposed between the third transfer gear TF3 and the sixth rotation element N6 in the previously described embodiments, the fourth clutch C4 is disposed between the first shaft IS1 and the third transfer gear TF3 in various embodiments described in FIG. 8.

Since functions and other components in the various embodiments described in FIG. 8 are same as those of previously described embodiments except the position of the fourth clutch C4, detailed description thereof will be omitted.

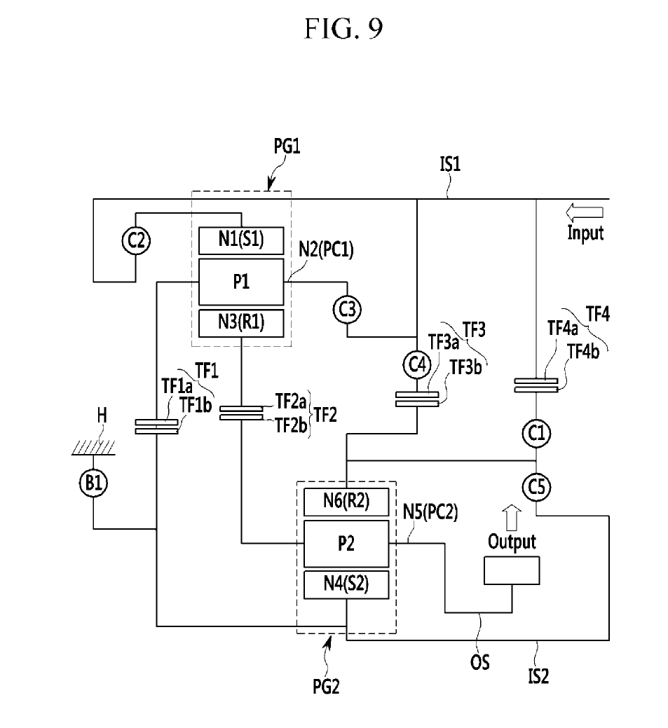

FIG. 9 is a schematic diagram of a planetary gear train according to various embodiments of the present invention.

Referring to FIG. 9, the fifth clutch C5 that is the direct-coupling device of the second planetary gear set PG2 is disposed between the fourth rotation element N4 and the fifth rotation element N5 in embodiments described in FIG. 8, but the fifth clutch C5 is disposed between the fourth rotation element N4 and the sixth rotation element N6 in the embodiments described in FIG. 9.

Since functions and other components in the embodiments described in FIG. 9 are same as those of the embodiments described in FIG. 8 except the position of the fifth clutch C5, detailed description will be omitted.

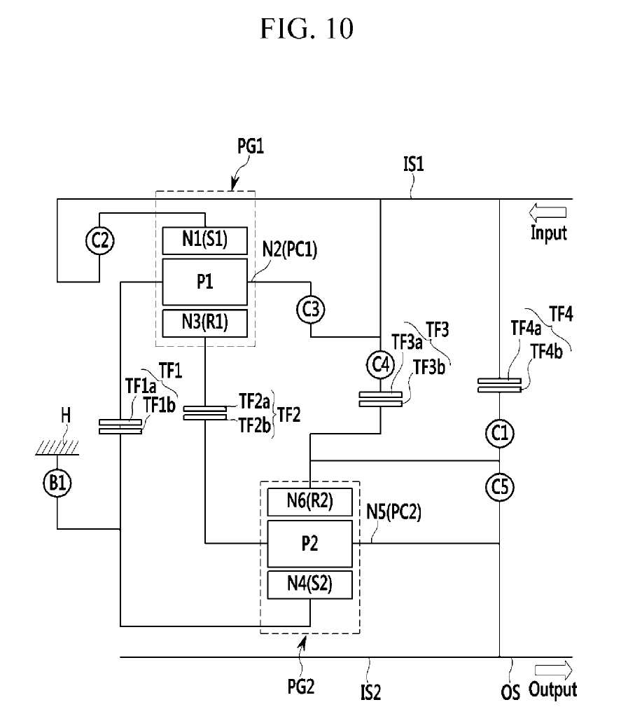

FIG. 10 is a schematic diagram of a planetary gear train according to various embodiments of the present invention.

Referring to FIG. 10, the fifth clutch C5 that is the direct-coupling device of the second planetary gear set PG2 is disposed between the fourth rotation element N4 and the fifth rotation element N5 in the embodiments described in FIG. 8, but the fifth clutch C5 is disposed between the fifth rotation element N5 and the sixth rotation element N6 in the embodiments described in FIG. 10.

Since functions and other components in the embodiments described in FIG. 10 are same as those of the embodiments described in FIG. 8 except the position of the fifth clutch C5, detailed description will be omitted.

Nine forward speeds and one reverse speed can be achieved by combining two planetary gear sets being simple planetary gear sets, four transfer gears, and six frictional elements according to various embodiments of the present invention.

In addition, since two planetary gear sets are disposed separately on the first shaft and the second shaft disposed in parallel with a predetermined distance, a length thereof may be reduced and mountability may be improved.

In addition, optimum gear ratios may be set due to ease of changing gear ratios by using four externally-meshed gears as well as the planetary gear sets. Since gear ratios can be changed according to target performance, starting performance, power delivery performance, and fuel economy may be improved. Therefore, a start-up clutch instead of a torque converter may be used.

In addition, two frictional elements are operated at each shift-speed and one frictional element is released and another frictional element is operated so as to shift to a neighboring shift-speed. Therefore, shift control condition is fully satisfied.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A planetary gear train of an automatic transmission for a vehicle comprising:
a first shaft receiving torque of an engine;
a second shaft disposed in parallel with the first shaft at a predetermined distance;
a first planetary gear set disposed on the first shaft, and including a first rotation element selectively connected to the first shaft, a second rotation element selectively connected to the first shaft and selectively connected to a transmission housing, and a third rotation element;
a second planetary gear set disposed on the second shaft, and including a fourth rotation element connected to the second rotation element through an externally-meshed gear and selectively connected to the transmission housing, a fifth rotation element connected to the third rotation element through an externally-meshed gear and directly connected to an output shaft, and a sixth rotation element selectively connected to the first shaft through two paths including respectively externally-meshed gears;
four transfer gears forming the externally-meshed gears; and
frictional elements including clutches selectively connecting the first shaft to rotation elements of the first and second planetary gear sets and a brake selectively connecting rotation elements of the first and second planetary gear sets to the transmission housing.

2. The planetary gear train of claim 1, wherein the first planetary gear set is a single pinion planetary gear set including a first sun gear being the first rotation element, a first planet carrier being the second rotation element, and a first ring gear being the third rotation element, and
the second planetary gear set is a single pinion planetary gear set including a second sun gear being the fourth rotation element, a second planet carrier being the fifth rotation element, and a second ring gear being the sixth rotation element.

3. The planetary gear train of claim 1, wherein the first planetary gear set is a double pinion planetary gear set including a first sun gear being the first rotation element, a first ring gear being the second rotation element, and a first planet carrier being the third rotation element, and
the second planetary gear set is a single pinion planetary gear set including a second sun gear being the fourth rotation element, a second planet carrier being the fifth rotation element, and a second ring gear being the sixth rotation element.

4. The planetary gear train of claim 1, wherein the first planetary gear set is a single pinion planetary gear set including a first sun gear being the first rotation element, a first planet carrier being the second rotation element, and a first ring gear being the third rotation element, and
the second planetary gear set is a double pinion planetary gear set including a second sun gear being the fourth rotation element, a second ring gear being the fifth rotation element, and a second planet carrier being the sixth rotation element.

5. The planetary gear train of claim 1, wherein the four transfer gears comprise:
a first transfer gear connecting the second rotation element to the fourth rotation element;
a second transfer gear connecting the third rotation element to the fifth rotation element;
a third transfer gear connecting the first shaft to the sixth rotation element; and
a fourth transfer gear connecting the first shaft to the sixth rotation element,
wherein a gear ratio of the third transfer gear differs from that of the fourth transfer gear.

6. The planetary gear train of claim 5, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the third transfer gear and the sixth rotation element;
a fifth clutch disposed between the fourth rotation element and the fifth rotation element; and
a first brake disposed between the fourth rotation element and the transmission housing.

7. The planetary gear train of claim 6, wherein the first clutch and the first brake are operated at a first forward speed,
the first clutch and the fifth clutch are operated at a second forward speed,
the first clutch and the second clutch are operated at a third forward speed,
the first clutch and the third clutch are operated at a fourth forward speed,
the second clutch and the third clutch are operated at a fifth forward speed,
the third clutch and the fifth clutch are operated at a sixth forward speed,
the third clutch and the fourth clutch are operated at a seventh forward speed,
the fourth clutch and the fifth clutch are operated at an eighth forward speed,
the second clutch and the fourth clutch are operated at a ninth forward speed, and
the second clutch and the first brake are operated at a reverse speed.

8. The planetary gear train of claim 5, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the third transfer gear and the sixth rotation element;
a fifth clutch disposed between the fourth rotation element and the fifth rotation element; and
a first brake disposed between the second rotation element and the transmission housing.

9. The planetary gear train of claim 5, wherein the frictional elements comprise:
a first clutch disposed between the first shaft and the fourth transfer gear;
a second clutch disposed between the first shaft and the first rotation element;
a third clutch disposed between the first shaft and the second rotation element;
a fourth clutch disposed between the third transfer gear and the sixth rotation element;
a fifth clutch disposed between the fourth rotation element and the fifth rotation element; and
a first brake disposed between the fourth rotation element and the transmission housing.

10. The planetary gear train of claim 5, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the first shaft and the third transfer gear;
a fifth clutch disposed between the fourth rotation element and the fifth rotation element; and
a first brake disposed between the fourth rotation element and the transmission housing.

11. The planetary gear train of claim 5, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the first shaft and the third transfer gear;
a fifth clutch disposed between the fourth rotation element and the sixth rotation element; and
a first brake disposed between the fourth rotation element and the transmission housing.

12. The planetary gear train of claim 5, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the first shaft and the third transfer gear;
a fifth clutch disposed between the fifth rotation element and the sixth rotation element; and
a first brake disposed between the fourth rotation element and the transmission housing.

13. A planetary gear train of an automatic transmission for a vehicle comprising:
a first shaft receiving torque of an engine;
a second shaft disposed in parallel with the first shaft;
a first planetary gear set disposed on the first shaft, and including a first rotation element selectively connected to the first shaft, a second rotation element selectively connected to the first shaft and selectively connected to a transmission housing, and a third rotation element;
a second planetary gear set disposed on the second shaft, and including a fourth rotation element connected to the second rotation element and selectively connected to the transmission housing, a fifth rotation element connected to the third rotation element and directly connected to an output shaft, and a sixth rotation element selectively connected to the first shaft through two paths;
a first transfer gear connecting the second rotation element to the fourth rotation element;
a second transfer gear connecting the third rotation element to the fifth rotation element;
a third transfer gear connecting the first shaft to the sixth rotation element;
a fourth transfer gear connecting the first shaft to the sixth rotation element; and
frictional elements including clutches selectively connecting the first shaft to rotation elements of the first and second planetary gear sets and a brake selectively connecting rotation elements of the first and second planetary gear sets to the transmission housing,
wherein a gear ratio of the third transfer gear differs from that of the fourth transfer gear.

14. The planetary gear train of claim 13, wherein the first planetary gear set is a single pinion planetary gear set including a first sun gear being the first rotation element, a first planet carrier being the second rotation element, and a first ring gear being the third rotation element, and
the second planetary gear set is a single pinion planetary gear set including a second sun gear being the fourth rotation element, a second planet carrier being the fifth rotation element, and a second ring gear being the sixth rotation element.

15. The planetary gear train of claim 13, wherein the first planetary gear set is a double pinion planetary gear set including a first sun gear being the first rotation element, a first ring gear being the second rotation element, and a first planet carrier being the third rotation element, and
the second planetary gear set is a single pinion planetary gear set including a second sun gear being the fourth rotation element, a second planet carrier being the fifth rotation element, and a second ring gear being the sixth rotation element.

16. The planetary gear train of claim 13, wherein the first planetary gear set is a single pinion planetary gear set including a first sun gear being the first rotation element, a first planet carrier being the second rotation element, and a first ring gear being the third rotation element, and
the second planetary gear set is a double pinion planetary gear set including a second sun gear being the fourth rotation element, a second ring gear being the fifth rotation element, and a second planet carrier being the sixth rotation element.

17. The planetary gear train of claim 13, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the third transfer gear and the sixth rotation element;
a fifth clutch disposed between the fourth rotation element and the fifth rotation element; and
a first brake disposed between the fourth rotation element and the transmission housing.

18. The planetary gear train of claim 17, wherein the first clutch and the first brake are operated at a first forward speed,
the first clutch and the fifth clutch are operated at a second forward speed,
the first clutch and the second clutch are operated at a third forward speed,
the first clutch and the third clutch are operated at a fourth forward speed,
the second clutch and the third clutch are operated at a fifth forward speed,
the third clutch and the fifth clutch are operated at a sixth forward speed,
the third clutch and the fourth clutch are operated at a seventh forward speed,
the fourth clutch and the fifth clutch are operated at an eighth forward speed,
the second clutch and the fourth clutch are operated at a ninth forward speed, and
the second clutch and the first brake are operated at a reverse speed.

19. The planetary gear train of claim 13, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the third transfer gear and the sixth rotation element;
a fifth clutch disposed between the fourth rotation element and the fifth rotation element; and
a first brake disposed between the second rotation element and the transmission housing.

20. The planetary gear train of claim 13, wherein the frictional elements comprise:
a first clutch disposed between the first shaft and the fourth transfer gear;
a second clutch disposed between the first shaft and the first rotation element;
a third clutch disposed between the first shaft and the second rotation element;
a fourth clutch disposed between the third transfer gear and the sixth rotation element;
a fifth clutch disposed between the fourth rotation element and the fifth rotation element; and
a first brake disposed between the fourth rotation element and the transmission housing.

21. The planetary gear train of claim 13, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the first shaft and the third transfer gear;
a fifth clutch disposed between the fourth rotation element and the fifth rotation element; and
a first brake disposed between the fourth rotation element and the transmission housing.

22. The planetary gear train of claim 13, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the first shaft and the third transfer gear;
a fifth clutch disposed between the fourth rotation element and the sixth rotation element; and
a first brake disposed between the fourth rotation element and the transmission housing.

23. The planetary gear train of claim 13, wherein the frictional elements comprise:
a first clutch disposed between the fourth transfer gear and the sixth rotation element;
a second clutch disposed between the first shaft and the first rotation element;
a third clutch disposed between the first shaft and the second rotation element;
a fourth clutch disposed between the first shaft and the third transfer gear;
a fifth clutch disposed between the fifth rotation element and the sixth rotation element; and
a first brake disposed between the fourth rotation element and the transmission housing.
